(19) United States
(12) Patent Application Publication
(10) Pub. No.: US 2018/0308400 A1
(43) Pub. Date: Oct. 25, 2018

(54) INTERACTIVE CLOTHING INCORPORATING ELECTRONIC COMPONENTS

(71) Applicant: WEARABLE WIFI, St-Colomban (CA)

(72) Inventors: Mathieu GIROUX VERREAULT, Ste-Marthe-sur-le-Lac (CA); Gilles TOURIGNY, St-Colomban (CA)

(21) Appl. No.: 15/731,072

(22) PCT Filed: May 26, 2016
(86) PCT No.: PCT/CA2016/000156

§ 371 Date: Apr. 13, 2017

(30) Foreign Application Priority Data
May 26, 2015 (GB) 1509008.7

(51) Int. Cl. G09F 21/02; G09F 9/30; A41D 1/00; A41D 27/08; A41B 1/08

(52) U.S. Cl. CPC G09F 21/02; G09F 9/30; G09F 2021/023; A41D 27/085; A41B 1/08; A41D 1/002

(57) ABSTRACT

An interactive clothing device (10) having electronic components has a controller (14) with a battery pack (16); a microprocessor (60) of the controller (14) controls at least one display member (12). A location unit (20) provides a location of the device (10), within a pre-determined zone, to the controller (14). Additional components can also be controlled by the microprocessor (60) such as a vibrating device, speaker, and electroluminescent elements (22). The device (10) works with a mobile application technology, to control the digital display (12) of one devices or a plurality of adjacent devices (10) located within the pre-determined zone. A system (110) formed of many devices (10) along with a network control unit (100) is also disclosed.

### CROSS-REFERENCE TO RELATED APPLICATIONS

Priority benefit of U.K. Patent Application Serial No. GB1509008.7 filed on May 26, 2015, being incorporated herein by reference, is hereby claimed.

### FIELD OF THE INVENTION

The present invention relates generally to clothing, and more particularly to interactive clothing having electronic components having wireless communication with surrounding electronic equipment, and the system of at least one interactive clothing with the operating control unit.

### BACKGROUND OF THE INVENTION

Current clothes are filled with printed images or embroidered motif. With advances in electronics and computer science, new types of clothing/garments and fabrics are being developed, which allows clothing to have any of a multitude of features. However, these clothes can't display digital images, which could be interesting in advertising, showing support during a sports match, or simply projecting an image for special occasions.

Furthermore, these garments or clothes cannot display specific images or portion of an image when surrounded by a plurality of adjacent similar clothes.

Accordingly, there is a need for an improved interactive electronic clothing device.

### SUMMARY OF THE INVENTION

It is therefore a general object of the present invention to provide an improved interactive electronic clothing device, that substantially solve the above-mentioned problems and drawbacks.

An advantage of the present invention is that the interactive electronic clothing device has controllable electronic components mounted thereon.

Another advantage of the present invention is that the interactive electronic clothing device can light up or simulate images at certain time or in interaction with third party applications such as a specific sports team, corporate event or individuals who would like to use this technology, especially with pre-determined zones.

Yet another advantage of the present invention is that the interactive electronic clothing device can be used to promote corporate sponsors of players and/or athletes.

A further advantage of the present invention is that the interactive electronic clothing device can also vibrate as well as having built-in speakers to imitate sounds, such as sports team rally songs and the like.

Another advantage of the present invention is that the interactive electronic clothing device can operate individually by being programmed from the wearer's smart phone by way of an app or the like, or it can be actuated by way of Bluteooth™, Wi-Fi or mobile access so that several pieces of clothing devices can work together by performing a set of activities, especially in the context of a large venues where several similar pieces of clothing devices can be located adjacent each other, preferably knowing their respective location relative to one another.

Yet a further advantage of the present invention is that the interactive electronic clothing device can use a special license that would be required to have access to a specific software for remotely programming the clothing device, such as when dealing with professional sports team owners or the like.

According to an aspect of the present invention there is provided a interactive electronic clothing device for wireless communication with an external operator network, said device comprising:
at least one display member mounted thereon for selectively emitting light;
a controller connecting to a power source and operatively connecting to the at least one display member, the controller including a communication unit for wirelessly communicating with the external operator network; and
a location unit connecting to the controller, the location unit providing a location of the device, within a pre-determined zone, to the controller and/or the external operator network.

In one embodiment, the at least one display member includes a pixel-screen area.

According to another aspect of the present invention there is provided a interactive electronic clothing device system:
at least one interactive electronic clothing device including at least one display member mounted thereon for selectively emitting light and a controller connecting to a power source, the controller operatively connecting to the at least one display member;
an external operator network selectively and a wirelessly communicating with a communication unit of the controller; and
a location unit connecting to the controller, the location unit providing a location of the device within a pre-determined zone to the controller and/or the external operator network.

In one embodiment, the at least one display member includes a pixel-screen area.

Conveniently, the at least one interactive electronic clothing device includes a plurality of adjacent interactive electronic clothing devices, the pixel-screen area of each one of the plurality of adjacent interactive electronic clothing devices displaying a portion of a larger image displayed by the plurality of display members, the portion of the larger image depending on a respective location of the interactive electronic clothing device relative to the others of the plurality of adjacent interactive electronic clothing devices.

Conveniently, the pre-determined zone is a grandstand of a stadium having a plurality of seats, the location of the device corresponding to a respective one of the plurality of seats.

In one embodiment, the external operator network includes a control unit, a personal digital assistant (PDA), or a Wi-Fi unit connecting to the at least one interactive electronic clothing device.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic front elevation view of an interactive electronic clothing device in accordance with an embodiment of the present invention;

FIG. 2 is a schematic view of the embodiment of FIG. 1 being in interaction with surrounding other similar embodiments and with a network control unit forming an interactive electronic clothing device system in accordance with the present invention; and

FIG. 3 is a schematic block diagram of a controller of the embodiment of FIG. 1.

### DETAILED DESCRIPTION OF THE INVENTION

With reference to the annexed drawings the preferred embodiment of the present invention will be herein described for indicative purpose and by no means as of limitation.

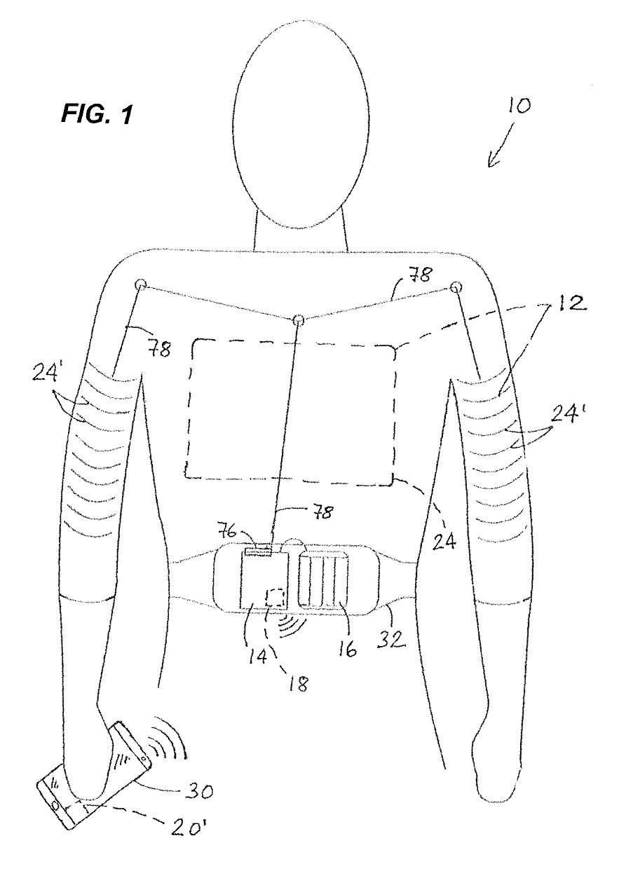

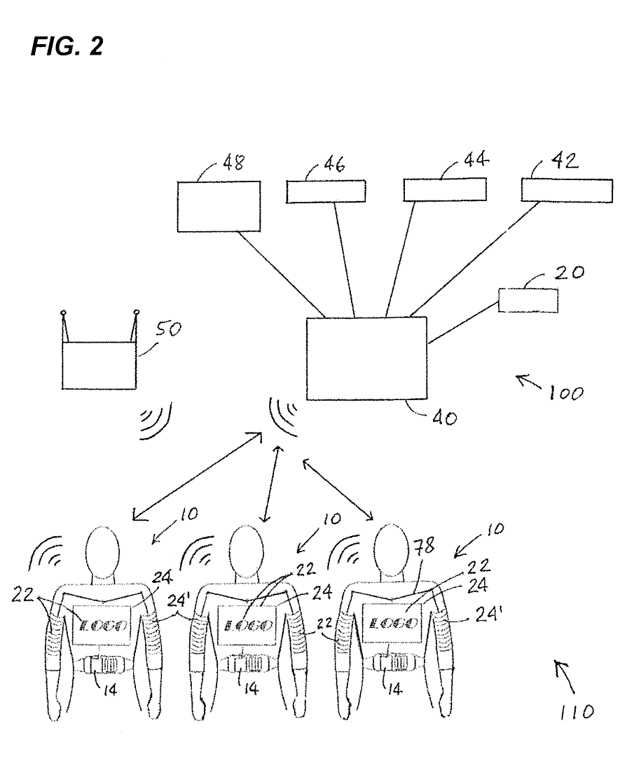

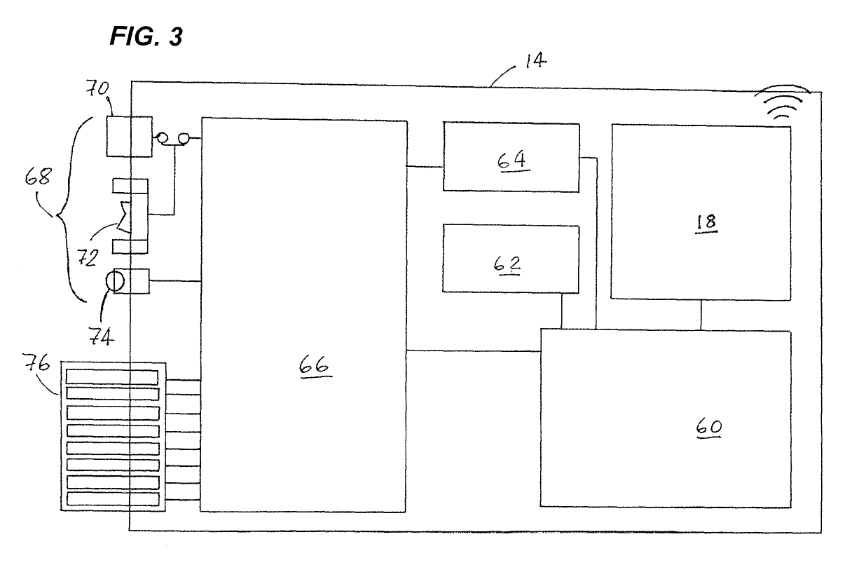

Referring to FIGS. 1 to 3, there is shown an interactive electronic clothing device 10 in accordance with an embodiment of the present invention, for wireless communication with an external operator network 100 or the like. The interactive clothing 10 typically has a plurality of electronic components as a controller box 14 and a power source 16, such as an external battery pack, internal battery (not shown) or the like, shown as mounted on a carrying belt 32 or the like. At least one display member 12 mounted on the device 10 and operatively connected to the controller 14, The display member 12 could be a plurality of electro-luminescent elements 22 as LEDs (Light Emitting Diodes) or the like, preferably low-power consumption, spread all over the device 10 or forming a specific area 24 delimited onto the device 10, such as a well-known logo (see FIG. 2) or the like (as a professional team in different sports or for advertisement), or sleeve(s) 24′. All elements 22 can present a pixel-screen shirt/area 24, which can show an image or video. For example, the device 10 can show an image set for one shirt, or can be used to project a portion of an larger illustration/image spread over a group of adjacent shirts/devices 10, when it is possible (like with a plurality of devices all located within a predetermined zone such as an arena, stadium or the like). Alternatively, because of the specific location of each device 10 within the pre-determined zone provided via a location unit 20 connected to the controller 14, the adjacent devices 10 can be used for publicity or advertisement, or to encourage people to do something (like the well-known wave moving along the grandstands within a stadium), or to shoot an image, and the like. The location unit 20′ could be located in a personal digital/electronic assistant (PDA) 30 (smart phone, tablet or the like) connecting to a device 10, or in a seat used by the user of a device 10, or provided from an application (within the PDA 30) used in connection with the device 10 onto which the seat reference number can be entered for communication with a control unit 40 of the external operator network 100 of the pre-determined zone or arena, via well known types of wireless communication protocols such as Wi-Fi™, Bluetooth™, Li-Fi™, iBeacon™, etc. Alternatively, the actual location of the devices 10 could be directly entered into the controller 14.

The control unit 40 of the external operator network 100 may also be in communication with the different devices 10 (or corresponding PDAs 30) via different known communication protocols using, for examples, through a DMX bridge 42 to control the different electro-luminescent elements 22, or a SMPTE bridge 44 to reproduce high definition full motion images on the display member 12 that can be a sophisticated “TV like” display, and the like. A user interface 46 connected to the control unit 40 could allow a user to program its device 10, while an auxiliary input 48 could be used to control other electronic components mounted on the device 10, such as speakers (not shown) and/or vibrating members (not shown). The broadcast of data to the different devices 10 could be by way of a Wi-Fi unit 50 or the like.

The control unit 40 of the external operator network 100 could be, for example, the production control or any organization, for them to be in a position to transmit a larger, yet coherent image to the different devices 10.

The devices 10 can be used, for example, to display scores and other written information which allow a group of friends to follow different sport teams (live scoring, winners, etc.) simultaneously when at a sport bar or the like, or when located within a geographical region (as a pre-determined zone) surrounding a city or the like.

Depending on the location where the device 10 is used, special license could be required to have access to a specific software for remotely programming the controller 14, such as professional sports team owners, or the like.

In order to do so, the controller 14 typically includes a microprocessor 60 controlling the at least one display member 12, and connected to a communication unit or module 18 (for communication with a PDA 30, the control unit 40 or a Wi-Fi unit 50). The microprocessor 60 also typically connects to an EEPROM module 62 containing the desired programmed data and to a analog to digital converter (ADC) 64 itself connected to a power regulator module 66 which supply the power to the other modules 18, 60, 64 and to the different electronic components, including the at least one display member 12. The power regulator module 66 receives its main power from the power source 16, preferably via a control panel 68 typically including a power connector 70, an on/off switch 72 and an operating LED indicator 74 or the like.

The controller 14 typically connects to the electronic components, including the at least one display member 12, via electrical wirings 78 running along the device 10 and connected to an output connector port 76 the power regulator module 66.

The present invention also contemplates the interactive electronic clothing device system 110 including at least one interactive electronic clothing device 10, preferably a plurality thereof, along with the external operator network 100 that would also be represented by PDAs 30 and/or a Wi-Fi unit 50.

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinabove described and hereinafter claimed.

We claim:

1. An interactive electronic clothing device (10) for wireless communication with an external operator network (100), said device comprising:
at least one display member (12) mounted thereon for selectively emitting light;
a controller (14) connecting to a power source (16) and operatively connecting to the at least one display member (12), the controller (14) including a communication unit (18) for wirelessly communicating with the external operator network (100); and
a location unit (20) connecting to the controller (14), the location unit (20) providing a location of the device (10), within a pre-determined zone, to the controller (14) and/or the external operator network (100).

2. The interactive electronic clothing device (10) of claim 1, wherein the at least one display member (12) includes a pixel-screen area (24).

3. An interactive electronic clothing device system (110) comprising:
at least one interactive electronic clothing device (10) including at least one display member (12) mounted thereon for selectively emitting light and a controller (14) connecting to a power source (16), the controller (14) operatively connecting to the at least one display member (12);
an external operator network (100) selectively and a wirelessly communicating with a communication unit (18) of the controller (14); and
a location unit (20) connecting to the controller (14), the location unit (20) providing a location of the device (10) within a pre-determined zone to the controller (14) and/or the external operator network (100).

4. The system (110) of claim 3, wherein the at least one display member (12) includes a pixel-screen area (24).

5. The system (110) of claim 4, wherein the at least one interactive electronic clothing device (10) includes a plurality of adjacent interactive electronic clothing devices (10), the pixel-screen area (24) of each one of the plurality of adjacent interactive electronic clothing devices (10) displaying a portion of a larger image displayed by the plurality of display members (12), the portion of the larger image depending on a respective location of the interactive electronic clothing device (10) relative to the others of the plurality of adjacent interactive electronic clothing devices (10).

6. The system (110) of any one of claims 3 and 5, wherein the pre-determined zone is a grandstand of a stadium having a plurality of seats, the location of the device (10) corresponding to a respective one of the plurality of seats.

7. The system (110) of any one of claims 3 to 6, wherein the external operator network (100) includes a control unit (40) connecting to the at least one interactive electronic clothing device (10).

8. The system (110) of any one of claims 3 to 6, wherein the external operator network (100) includes a personal digital assistant (30) connecting to the at least one interactive electronic clothing device (10).

9. The system (110) of any one of claims 3 to 6, wherein the external operator network (100) includes a Wi-Fi unit (50) connecting to the at least one interactive electronic clothing device (10).
